(19) United States
(12) Patent Application Publication
(10) Pub. No.: US 2020/0148809 A1
(43) Pub. Date: May 14, 2020

(54) PROCESS FOR THE PREPARATION OF ALICYCLIC POLYISOCYANATE

(71) Applicant: BASF SE, Ludwigshafen am Rhein (DE)

(72) Inventors: Frederic LUCAS, Ludwigshafen (DE); Alexander PANCHENKO, Ludwigshafen (DE); Klaus BREUER, Ludwigshafen (DE); Frank HETTCHE, Ludwigshafen (DE); Chee Kean THAM, Hong Kong (CN)

(73) Assignee: BASF SE, Ludwigshafen am Rhein (DE)

(21) Appl. No.: 16/614,202

(22) PCT Filed: May 7, 2018
(86) PCT No.: PCT/EP2018/061644

§ 371 Date: Nov. 15, 2019

(30) Foreign Application Priority Data
May 17, 2017 (EP) 17171588.1

(51) Int. Cl. C08G 18/75; C08G 18/80; C08G 18/32

(52) U.S. Cl. CPC C08G 18/751; C08G 18/3206; C08G 18/8016; C08G 18/8025

(57) ABSTRACT

The present invention relates to a polyisocyanate (P) of general formula (I), the method for preparing polysisocyanate (P) of general formula (I) and the use of polyisocyanate (P) of general formula (I) as crosslinking reagent in clearcoats. The method for preparing polyisocyanate (P) of general formula (I) comprises the reaction of a reaction mixture (RM), which comprises at least one cyclic isocyanate of general formula (IIIa), (IIIb), (IIIc), (IIId), (IIIe) and/or (IIIf) and at least one alcohol having at least two hydroxyl groups, to obtain polyisocyanate (P) of general formula (I).

The present invention relates to a polyisocyanate (P) of general formula (I), the method for preparing polysisocyanate (P) of general formula (I) and the use of polyisocyanate (P) of general formula (I) as crosslinking reagent in clearcoats. The method for preparing polyisocyanate (P) of general formula (I) comprises the reaction of a reaction mixture (RM), which comprises at least one cyclic isocyanate of general formula (IIIa), (IIIb), (IIIc), (IIId), (IIIe) and/or (IIIf) and at least one alcohol having at least two hydroxyl groups, to obtain polyisocyanate (P) of general formula (I).

Organic polyisocyanates play a critical role in the sector of plastics, molding compositions and adhesive bonds, especially in the lacquer industry. Owing to the toxicity of organic isocyanates, these are generally reacted with polyalcohols to obtain products having a relatively low vapor pressure. Low molecular weight and storage-stable polyurethanes are largely formed in this case, which have further reactive isocyanate groups and which are distinctly less physiologically harmful than the organic isocyanate starting materials. The polyurethanes thus obtained, however, often have a lower content of isocyanate groups compared to the organic isocyanate starting material which is why more material has to be used in order that the desired amount of isocyanate groups is present for further reactions.

The preparation of polyisocyanates from organic isocyanates and alcohols is described in the prior art.

For instance, US-A 2015/0183922 discloses a polyisocyanate composition based on bis(isocyanatomethyl)cyclohexane and trimethylolpropane. In this case, the polyisocyanate composition comprises both the reaction product of one molecule of trimethylolpropane with three molecules of bis(isocyanatomethyl)cyclohexane and the reaction product of two molecules of trimethylolpropane with five molecules of bis(isocyanatomethyl)cyclohexane. These reaction products are used as crosslinkers in addition to further aliphatic, aromatic and araliphatic polyisocyanates and polyisocyanate derivatives.

WO 2009/071533 discloses allophanate group-containing polyisocyanates, which are obtained by reacting isophorone diisocyanate with a polyalcohol or a hydroxyl group-containing amine in the presence of a catalyst. The allophanate group-containing polyisocyanates are used in two-component polyurethane lacquers in addition to at least one component that comprises groups that are reactive to isocyanate. Here, the allophanate group-containing polyisocyanates serve as crosslinker component. U.S. Pat. No. 3,595,838 discloses polyurethane-containing lacquer compositions comprising a polyester polyol and an isocyanate compound. The isocyanate compound is an adduct of trimethylolpropane and bis(isocyanatomethyl)benzene. To prepare this adduct, the isocyanate is used in a seven-fold to sixteen-fold excess over trimethylolpropane, so that the adduct is sufficiently soluble in solvents and compatible with the polyester polyol.

DE-A 1090196 discloses a method for preparing mono- or polyisocyanates having low vapor pressure in which one or more alcohols are used with a large excess of diisocyanates. Suitable alcohols are saturated and unsaturated glycols and polyols.

DE-A 953012 discloses a method for preparing polyisocyanates, in which, similar to DE-A 1090196, low molecular weight polyhydric alcohols are reacted with an excess of aliphatic and/or aromatic diisocyanates. The alcohols used are trihydric or tetrahydric alcohols such as trimethylolpropane, glycerol, pentaerythritol or triethanolamine, which are optionally used in a mixture with dihydric alcohols such as ethylene glycol or butylene glycol.

Analogous to this, DE-B 870400 also describes the preparation of organic polyisocyanates by reacting trihydric or tetrahydric alcohols, which may be present in the mixture with dihydric alcohols, with at least one mole of diisocyanate. Listed as diisocyanates are aliphatic diisocyanates such as tetramethylene diisocyanate or hexamethylene diisocyanate. The aromatic diisocyanates listed in DE-B 870400 include, for example, tolylene diisocyanate and diphenylene diisocyanate.

The object of the present invention, therefore, is to provide a novel polyisocyanate and also a method for the preparation thereof.

The object is achieved by the polyisocyanate (P) of general formula (I):

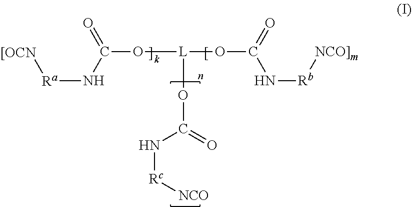

in which
k, m, n are each independently 0, 1, 2 or 3, wherein the sum total of k, m and n is at least 2 and at most 6; and
L is a linear or branched organic radical having at most 14 carbon atoms, which may optionally comprise at least one nitrogen atom and/or at least one oxygen atom,
R^{a}, R^{b}, R^{c} are each independently selected from radicals of general formulae (IIa), (IIb), (IIc), (IId), (IIe) and/or (IIf):

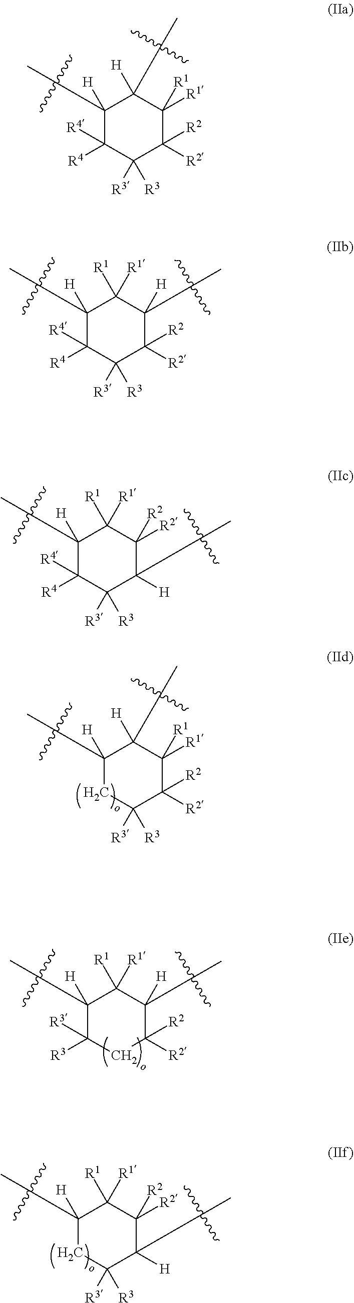

in which
o is 0 to 10, and
R¹, R^{1′}, R², R^{2′}, R³, R^{3′}, R⁴, R^{4′} are each independently selected from the group consisting of H, OR⁵ and unsubstituted or at least monosubstituted C₁-C₁₀-alkyl, C₅-C₁₂-cycloalkyl, C₂-C₁₀-alkenyl and C₆-C₁₄-aryl, where R⁵ is C₁-C₁₀-alkyl.

It has been found that, surprisingly, polyisocyanates (P) of general formula (I) have a higher content of isocyanate groups with comparable viscosity, compared to the polyisocyanates described in the prior art. As a result, compared to methods described in the prior art, a lower amount of polyisocyanate is required for further reactions which reduces the production costs of conversion products.

In the context of the present invention, a polyisocyanate is understood to mean an organic compound comprising two or more isocyanate groups (—NCO).

In the context of the present invention, a polyurethane is understood to mean an organic compound comprising two or more urethane groups (—O—CO—NH—).

In the context of the present invention, definitions such as “C₁-C₁₀-alkyl”, for example such as defined for the radicals R¹ to R^{4′} in formulae (IIa) to (IIf), signify that this substituent can be an alkyl radical having 1 to 10 carbon atoms. Unless otherwise stated, this can be linear or branched, but may also have a proportion of both forms at the same time. Examples of corresponding alkyl radicals are methyl, ethyl, propyl, isopropyl, butyl, tert-butyl, sec-butyl, pentyl, hexyl, heptyl, octyl, nonyl and decyl.

In the context of the present invention, definitions such as “C₅-C₁₂-cycloalkyl”, for example such as defined for the radicals R¹ to R^{4′} in formulae (IIa) to (IIf), signify that this substituent can be a cycloalkyl radical having 5 to 12 carbon atoms. Examples of corresponding cycloalkyl radicals are cyclopentyl, cyclohexyl, cycloheptyl, cyclooctyl, norbornyl or adamantyl.

In the context of the present invention, definitions such as “C₆-C₁₄-aryl”, for example such as defined for the radicals R¹ to R^{4′} in formulae (IIa) to (IIf), signify that this substituent can be an aromatic system having 6 to 14 carbon atoms. The aromatic system can be a monocylic, bicyclic or polycyclic aromatic system. In the case of polycyclic aromatic systems, individual rings may be fully or partially saturated. Examples of corresponding aryl radicals are phenyl, naphthyl, anthracyl or phenanthryl.

In the context of the present invention, definitions such as “C₂-C₁₀-alkenyl”, such as defined for the radicals R¹ to R^{4′} in formulae (IIa) to (IIf), signify that this substituent can be an alkenyl radical having 2 to 10 carbon atoms. This carbon radical is preferably monounsaturated but it may also be di- or polyunsaturated. In the context of the present invention, C₂-C₁₀-alkenyl is vinyl, 1-allyl, 2-allyl, 3-allyl, cis- or trans-2-butenyl or w-butenyl.

The designation “unsubstituted” in the context of the present invention signifies that C₁-C₁₀-alkyl, C₅-C₁₂-cycloalkyl, C₂-C₁₀-alkenyl or C₆-C₁₄-aryl have no further substituents other than hydrogen (H).

The designation “at least monosubstituted” in the context of the present invention signifies that C₁-C₁₀-alkyl, C₅-C₁₂-cycloalkyl or C₆-C₁₄-aryl may have exactly one substituent or also two or more substituents. The substituents can be the same or different and are C₁-C₁₀-alkyl, which have been defined above.

The present invention is elucidated in detail hereinbelow.

The polyisocyanate (P) has the general formula (I):

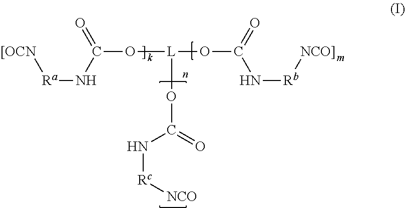

in which
k, m, n are each independently 0, 1, 2 or 3, wherein the sum total of k, m and n is at least 2 and at most 6; and
L is a linear or branched organic radical having at most 14 carbon atoms, which may optionally comprise at least one nitrogen atom and/or at least one oxygen atom,
R^{a}, R^{b}, R^{c} are each independently selected from radicals of general formulae (IIa), (IIb), (IIc), (IId), (IIe) and/or (IIf):

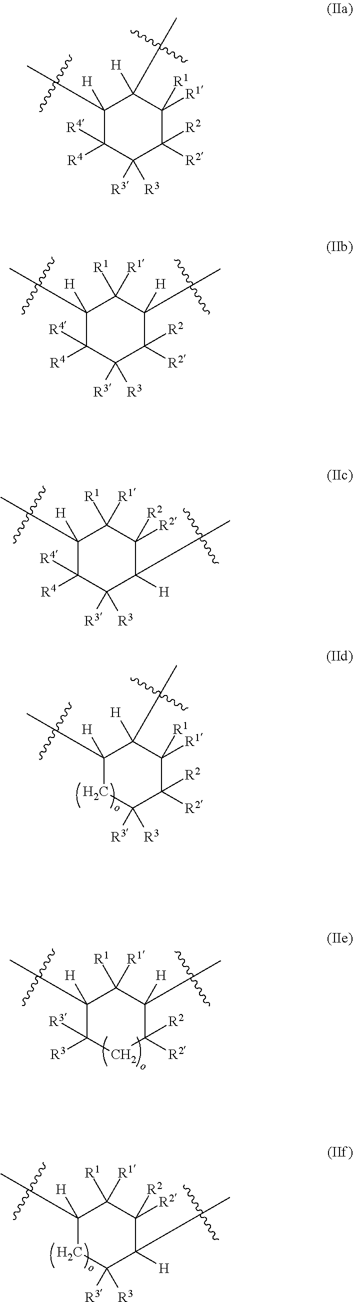

in which
o is 0 to 10, and
R¹, R^{1′}, R², R^{2′}, R³, R^{3′}, R⁴, R^{4′} are each independently selected from the group consisting of H, OR⁵ and unsubstituted or at least monosubstituted C₁-C₁₀-alkyl, C₅-C₁₂-cycloalkyl, C₂-C₁₀-alkenyl and C₆-C₁₄-aryl, where R⁵ is C₁-C₁₀-alkyl.

k, m and n are each independently 0, 1, 2 or 3. The sum total of k, m and n in this case is at least 2 and at most 6, particularly preferably at most 4.

Preferably, k is at least 2, particularly preferably at least 3 and at most 4, and m and n are 0. The values for k, m and n can assume odd-numbered values on statistical average, but they are even-numbered based on each individual molecule of isocyanate (P) of general formula (I).

L in accordance with the invention is a linear or branched organic radical having at most 14 carbon atoms, which may optionally comprise at least one nitrogen atom and/or at least one oxygen atom, L comprising at least one, preferably at least two carbon atoms.

The number of nitrogen and/or oxygen atoms is not restricted. In the radical, it is generally not more than 5, preferably not more than 4 and more preferably not more than 3, L particularly preferably comprising a maximum of one nitrogen or one oxygen atom. Furthermore, there is generally at least one carbon atom, preferably at least two carbon atoms, between two nitrogen and/or oxygen atoms. In a preferred embodiment, L does not comprise any heteroatoms (i.e. N or O).

L is preferably a linear or branched, (k+m+n)-valent, preferably divalent to hexavalent, particularly preferably divalent to tetravalent and especially preferably trivalent organic radical, which is bonded, depending on its valency, to two to six, particularly preferably two to four and especially preferably to three urethane groups. In the context of the present application, “valency” is understood to mean the number of urethane group-containing radicals which are substituted by an organic radical L.

L is preferably a linear or branched aliphatic, cycloaliphatic or aromatic radical having at most 14 carbon atoms, which may optionally comprise at least one nitrogen atom and/or at least one oxygen atom. Suitable linear or branched aliphatic, cycloaliphatic or aromatic radicals are derived from corresponding (k+m+n)-hydric alcohols, which are described further in more detail below.

L is more preferably a linear or branched aliphatic or cycloaliphatic radical having at most 14 carbon atoms, which may optionally comprise at least one nitrogen atom and/or at least one oxygen atom.

L is even more preferably a linear or branched aliphatic radical having at most 10 carbon atoms, which may optionally comprise at least one nitrogen atom and/or at least one oxygen atom.

L is particularly preferably a linear or branched aliphatic radical having at most 6 carbon atoms, which may optionally comprise at least one oxygen atom.

The radicals R^{a}, R^{b} and R^{c} of general formulae (IIa), (IIb), (IIc), (IId), (IIe) and/or (IIf) are molecular fragments within the polyisocyanate (P). It is clear here to those skilled in the art that the wavy lines in general formulae (IIa), (IIb), (IIc), (IId), (IIe) and (IIf) show the end of the corresponding molecular fragments and that the corresponding molecular fragment is bonded at these points to the nitrogen atoms of the isocyanate groups or the nitrogen atoms of the urethane groups of the polyisocyanate (P).

Preferably, R^{a}, R^{b} and R^{c} in general formula (I) are each independently selected from radicals of general formulae (IIa), (IIb), (IIc), (IId), (IIe) and/or (IIf), in which o is 0, 2 or 3 and R¹, R^{1′}, R², R^{2′}, R³, R^{3′}, R⁴ and R^{4′} are each independently selected from the group consisting of H and unsubstituted or at least monosubstituted C₁-C₁₀-alkyl.

More preferably, R^{a}, R^{b} and R^{c} in general formula (I) are each independently selected from radicals of general formulae (IIa), (IIb) and/or (IIc), in which R¹, R^{1′}, R², R^{2′}, R³, R^{3′}, R⁴ and R^{4′} are each independently selected from the group consisting of H, methyl, ethyl and propyl.

Even more preferably, R^{a}, R^{b} and R^{c} in general formula (I) are selected from radicals of general formulae (IIa), (IIb) and/or (IIc), in which R¹, R^{1′}, R², R^{2′}, R³, R^{3′}, R⁴ and R^{4′} are each independently selected from the group consisting of H, methyl and ethyl, wherein at least one radical R¹, R^{1′}, R², R^{2′}, R³, R^{3′}, R⁴ or R^{4′} is methyl or ethyl, preferably methyl.

Particularly preferably, R^{a}, R^{b} and R^{c} in general formula (I) are radicals of general formula (IIb), in which R¹, R^{1′}, R², R^{2′}, R³, R^{3′}, R⁴ and R^{4′} are each independently selected from the group consisting of H, methyl and ethyl, wherein at least one radical and at most 3 radicals R¹, R^{1′}, R², R^{2′}, R³, R^{3′}, R⁴ or R^{4′} are methyl or ethyl, preferably methyl.

Especially preferably, R^{a}, R^{b} and R^{c} in general formula (I) are a radical of general formula (IIb), in which R¹, R^{1′}, R² and R^{2′} are each independently selected from the group consisting of H and methyl, wherein at least one radical and at most 3 radicals R¹, R^{1′}, R² and R^{2′} are methyl, and in which R³, R^{3′}, R⁴ and R^{4′} are H.

In a preferred embodiment, the polyisocyanate (P) has the general formula (I), in which
k, m, n are each independently 0, 1, 2 or 3, wherein the sum total of k, m and n is at least 2 and at most 6; and
L is a linear or branched aliphatic, cycloaliphatic or aromatic radical having at most 14 carbon atoms, which may optionally comprise at least one nitrogen atom and/or at least one oxygen atom,
R^{a}, R^{b}, R^{c} are each independently selected from radicals of general formulae (IIa), (IIb), (IIc), (IId), (IIe) and/or (IIf), in which
o is 0, 2 or 3, and
R¹, R^{1′}, R², R^{2′}, R³, R^{3′}, R⁴, R^{4′} are each independently selected from the group consisting of H and C₁-C₁₀-alkyl.

In a more preferred embodiment, the polyisocyanate (P) has the general formula (I), in which
k, m, n are each independently 0, 1, 2 or 3, wherein the sum total of k, m and n is at least 2 and at most 6; and
L is a linear or branched aliphatic or cycloaliphatic radical having at most 14 carbon atoms, which may optionally comprise at least one nitrogen atom and/or at least one oxygen atom,
R^{a}, R^{b}, R^{c} are each independently selected from radicals of general formulae (IIa), (IIb) and/or (IIc), in which
R¹, R^{1′}, R², R^{2′}, R³, R^{3′}, R⁴, R^{4′} are each independently selected from the group consisting of H, methyl, ethyl and propyl.

In a still more preferred embodiment, the polyisocyanate (P) has the general formula (I), in which
k is 2 or 3, and
m, n are 0, and
L is a linear or branched aliphatic radical having at most 10 carbon atoms, which may optionally comprise at least one nitrogen atom and/or at least one oxygen atom,
R^{a} is selected from the radicals of general formula (IIa), (IIb) and/or (IIc), in which
R¹, R^{1′}, R², R^{2′}, R³, R^{3′}, R⁴, R^{4′} are each independently selected from the group consisting of H, methyl and ethyl,
   wherein at least one radical R¹, R^{1′}, R², R^{2′}, R³, R^{3′}, R⁴ or R^{4′} is methyl or ethyl, preferably methyl.

In a particularly preferred embodiment, the polyisocyanate (P) has the general formula (I), in which
k is 3, and
m, n are 0, and
L is a linear or branched aliphatic radical having at most 6 carbon atoms, which may optionally comprise at least one oxygen atom,
R^{a} is a radical of general formula (IIb), in which
R¹, R^{1′}, R², R^{2′}, R³, R^{3′}, R⁴, R^{4′} are each independently selected from the group consisting of H, methyl and ethyl,
   wherein at least one radical and at most 3 radicals R¹, R^{1′}, R², R^{2′}, R³, R^{3′}, R⁴ or R^{4′} are methyl or ethyl, preferably methyl.

In an especially preferred embodiment, the polyisocyanate (P) has the general formula (I), in which
k is 3 and
m, n are 0, and
L is a linear or branched aliphatic radical having at most 6 carbon atoms, which may optionally comprise at least one oxygen atom,
R^{a} is a radical of general formula (IIb), in which
R¹, R^{1′}, R², R^{2′}, R³, R^{3′}, R⁴, R^{4′} are each independently selected from the group consisting of H, methyl and ethyl,
   wherein at least one radical and at most 3 radicals R¹, R^{1′}, R², R^{2′}, R³, R^{3′}, R⁴ or R^{4′} are methyl or ethyl, preferably methyl.

In a most preferred embodiment, the polyisocyanate (P) has the general formula (IV):

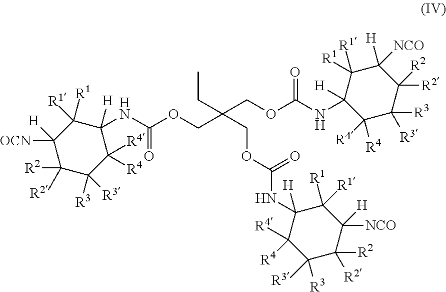

in which
R¹, R^{1′}, R², R^{2′} are each independently selected from the group consisting of H and methyl, wherein at least one radical and at most two radicals R¹, R^{1′}, R² or R^{2′} are methyl, and
R³, R³, R⁴ and R⁴ are H.

A further subject of the present invention is also a method for preparing the polyisocyanate (P) comprising the reaction of a reaction mixture (RM), comprising the following components (a) and (b):
(a) at least one cyclic isocyanate of general formulae (IIIa), (IIIb), (IIIc), (IIId), (IIIe) and/or (IIIf):

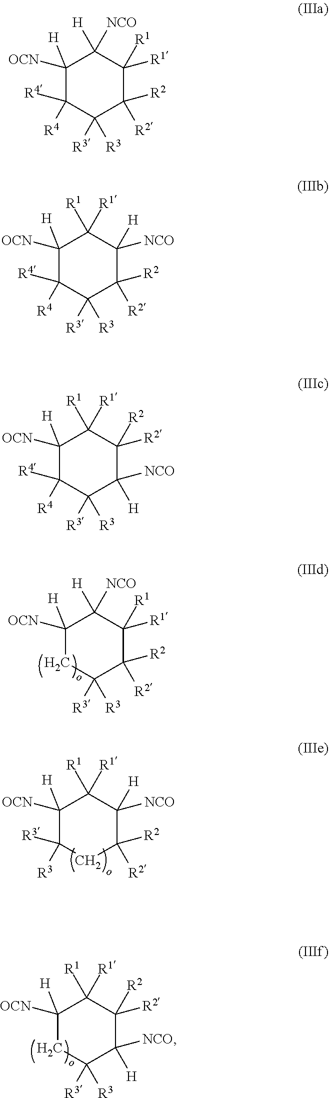

in which
o is 0 to 10, and
R¹, R^{1′}, R², R^{2′}, R³, R^{3′}, R⁴, R^{4′} are each independently selected from the group consisting of H, OR⁵ and unsubstituted or at least monosubstituted C₁-C₁₀-alkyl, C₅-C₁₂-cycloalkyl, C₂-C₁₀-alkenyl and C₆-C₁₄-aryl, where R⁵ is C₁-C₁₀-alkyl, and
(b) at least one alcohol having at least two hydroxyl groups,
to obtain polyisocyanate (P).

The polyisocyanate (P) is prepared by the method elucidated in detail below.

In the method according to the invention, a reaction mixture (RM) comprising a cyclic isocyanate of general formulae (IIIa), (IIIb), (IIIc), (IIId), (IIIe) and/or (IIIf) (component (a)) and at least one alcohol having at least two hydroxyl groups (component (b)) is reacted to obtain a composition (C), which comprises the polyisocyanate (P) of general formula (I).

The components (a) and (b) are elucidated in detail hereinafter.

The reaction mixture (RM) comprises as component (a) at least one cyclic isocyanate of general formulae (IIIa), (IIIb), (IIIc), (IIId), (IIIe) and/or (IIIf).

The designation “component (a)” and “at least one cyclic isocyanate of general formulae (IIIa), (IIIb), (IIIc), (IIId), (IIIe) and/or (IIIf)” are used synonymously in the context of the present invention.

The designation “at least one cyclic isocyanate” refers in this case to both exactly one cyclic isocyanate and to mixtures of two or more cyclic isocyanates of general formulae (IIIa), (IIIb), (IIIc), (IIId), (IIIe) and/or (IIIf).

Suitable cyclic isocyanates and methods for the preparation thereof are known in principle to those skilled in the art and can be prepared, for example, by phosgenating the amines from which they are derived.

The at least one cyclic isocyanate used in the method according to the invention has at least one of the general formulae (IIIa), (IIIb), (IIIc), (IIId), (IIIe) and/or (IIIf):

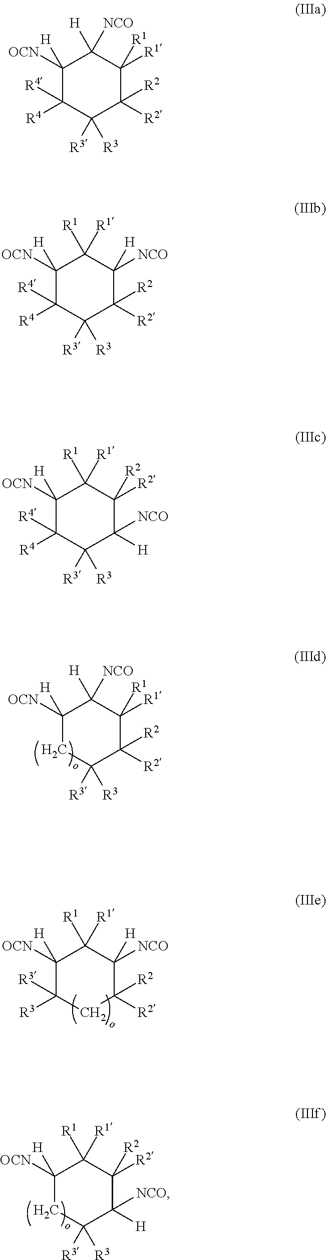

in which
o is 0 to 10, and
R¹, R^{1′}, R², R^{2′}, R³, R^{3′}, R⁴, R^{4′} are each independently selected from the group consisting of H, OR⁵ and unsubstituted or at least monosubstituted C₁-C₁₀-alkyl, C₅-C₁₂-cycloalkyl, C₂-C₁₀-alkenyl and C₆-C₁₄-aryl, where R⁵ is C₁-C₁₀-alkyl.

The radicals R¹ to R^{4′} in the at least one cyclic isocyanate of general formulae (IIIa), (IIIb), (IIIc), (IIId), (IIIe) and/or (IIIf) are in principle identical to the radicals R¹ to R^{4′} in formulae (IIa) to (IIf) of polyisocyanate (P) of general formulae (I) or (IV). As a consequence, the details and preferences above relating to the radicals R¹ to R^{4′} in general formulae (IIIa) to (IIIf) apply accordingly to the radicals R¹ to R^{4′} in formulae (IIa) to (IIf) of polyisocyanate (P) of general formula (I) or (IV).

Consequently, in order to obtain a certain polyisocyanate (P), it is clear to those skilled in the art that at least one cyclic isocyanate of general formulae (IIIa), (IIIb), (IIIc), (IIId), (IIIe) and/or (IIIf) must be used as component (a), which does not differ in the radicals R^{1′} to R^{4′} from the corresponding radicals R^{1′} to R^{4′} in formulae (IIa) to (IIf) in polyisocyanate (P) of general formulae (I) or (IV).

Component (a) is preferably selected from 1,3-diisocyanatocyclohexane, 1,3-diisocyanato-2-methylcyclohexane, 1,3-diisocyanato-4-methylcyclohexane, 1,3-diisocyanato-5-methylcyclohexane, 1,3-diisocyanato-2-isopropylcyclohexane, 1,3-diisocyanato-4-isopropylcylohexane, 1,3-diisocyanato-5-isopropylcyclohexane, 1,3-diisocyanato-2,4-dimethylcyclohexane, 1,3-diisocyanato-2,4-diethylcyclohexane, 1,3-diisocyanato-2,4-diethyl-6-methylcyclohexane, 1,3-diisocyanato-2-methyl-4,5-diethylcyclohexane, 1,3-diisocyanato-2,4,6-triisopropylcyclohexane or 1,3-diisocyanato-2,4,6-tributylcyclohexane.

Component (a) is more preferably selected from 1,3-diisocyanatocyclohexane, 1,3-diisocyanato-2-methylcyclohexane, 1,3-diisocyanato-4-methylcyclohexane, 1,3-diisocyanato-5-methylcyclohexane, 1,3-diisocyanato-2,4-dimethylcyclohexane, 1,3-diisocyanato-2,4-diethylcyclohexane and 1,3-diisocyanato-2,4-diethyl-6-methylcyclohexane.

Still more preferably, component (a) comprises at least 80% by weight, preferably at least 90% by weight and particularly preferably at least 98% by weight of at least one cyclic isocyanate selected from 1,3-diisocyanato-2-methylcyclohexane or 1,3-diisocyanato-4-methylcyclohexane, based on the total weight of component (a) in the reaction mixture (RM).

Component (a) particularly preferably consists of at least one cyclic isocyanate selected from 1,3-diisocyanato-2-methylcyclohexane or 1,3-diisocyanato-4-methylcyclohexane.

Component (a) is preferably a mixture of 1,3-diisocyanato-2-methylcyclohexane and 1,3-diisocyanato-4-methylcyclohexane. The weight fractions of 1,3-diisocyanato-2-methylcyclohexane and 1,3-diisocyanato-4-methylcyclohexane in this mixture may in principle take any desired values.

Component (a) in this case preferably comprises 50 to 95% by weight of 1,3-diisocyanato-4-methylcyclohexane and 5 to 50% by weight of 1,3-diisocyanato-2-methylcyclohexane, based on the total weight of component (a).

Component (a) used in the method according to the invention preferably has a molecular weight in the range of 130 to 500 g/mol, particularly preferably 140 to 350 g/mol.

The reaction mixture (RM) comprises as component (b) at least one alcohol having at least two hydroxyl groups. The designation “hydroxyl group” is understood in the context of the present invention to mean —OH.

The designation “component (b)” and “at least one alcohol having at least two hydroxyl groups” are used synonymously here in the context of the present invention.

The designation “at least one alcohol” refers here to exactly one alcohol and to mixtures of two or more different alcohols having at least two hydroxyl groups. In the context of the present invention, the designation “at least two hydroxyl groups” is understood to mean that component (b) may have exactly two hydroxyl groups and three or more hydroxyl groups. Suitable alcohols having at least two hydroxyl groups are generally known to those skilled in the art.

Component (b) is preferably selected from ethylene glycol, 1,1-dimethylethylene glycol, 1,2-propanediol, 1,3-propanediol, 2-methyl-1,3-propanediol, 2-ethyl-1,3-propanediol, 2-butyl-2-ethyl-1,3-propanediol, 1,4-butanediol, 2-ethyl-1,4-butanediol, 1,5-pentanediol, 2-methyl-1,5-pentanediol, neopentyl glycol, 1,6-hexanediol, 2-ethyl-1,3-hexanediol, 2,4-diethyloctane-1,3-diol, diethylene glycol, triethylene glycol, tetraethylene glycol, pentaethylene glycol, dipropylene glycol, tripropylene glycol, trimethylolethane, trimethylolpropane, trimethylolbutane, ditrimethylolpropane, pentaerythritol, dipentaerythritol, glycerol, cyclohexane-1,2-diol, cyclohexane-1,3-diol, cyclohexane-1,4-diol, 1, 1-bis(hydroxymethyl)cyclohexane, 1,2-bis(hydroxymethyl)cyclohexane, 1,3-bis(hydroxymethyl)cyclohexane, 1,4-bis(hydroxymethyl)cyclohexane, 2,2-bis(4-hydroxycyclohexyl)propane, erythritol, threitol, xylitol, adonitol (ribitol), arabitol (lyxitol), sorbitol, mannitol, dulcitol (galactitol), maltitol, isomalt, diglycerol, dimethylolpropane, dipentaerythritol, ribose, arabinose, glucose, mannose, galactose, fructose, pyrocatechol, catechol, hydroquinone, pyrogallol, hydroxyhydroquinone, phloroglucinol, neopentyl glycol hydroxypivalate, triethanolamine, tripropanolamine, 1,3,5-tris(2-hydroxyethyl)cyanuric acid, polytetrahydrofuran having a molecular weight between 162 and 4500 g/mol, preferably 250 to 2000 g/mol, poly-1,3-propanediol or poly-1,2-propanediol having a molecular weight between 134 and 2000 g/mol or polyethylene glycol having a molecular weight between 238 and 2000 g/mol.

Component (b) is more preferably selected from ethylene glycol, 1,2-propanediol, 1,3-propanediol, 1,4-butanediol, 1,5-pentanediol, 1,6-hexanediol, diethylene glycol, triethylene glycol, trimethylolpropane, trimethylolbutane, pentaerythritol, glycerol, erythritol, threitol, xylitol, ribitol, arabitol, sorbitol, mannitol, galactitol, diglycerol, dimethylolpropane or dipentaerythritol.

Still more preferably, component (b) is selected from ethylene glycol, 1,2-propanediol, 1,3-propanediol, 1,4-butanediol, diethylene glycol, trimethylolethane, trimethylolpropane, trimethylolbutane and glycerol.

Component (b) is particularly preferably selected from ethylene glycol, 1,2-propanediol, 1,3-propanediol, 1,4-butanediol, diethylene glycol, trimethylolpropane and glycerol.

Component (b) preferably comprises at least 80% by weight, preferably at least 90% by weight and particularly preferably at least 98% by weight of at least one alcohol selected from the group consisting of ethylene glycol, 1,2-propanediol, 1,3-propanediol, 1,4-butanediol, diethylene glycol, trimethylolethane, trimethylolpropane, trimethylolbutane and glycerol, based on the total weight of component (b) in the reaction mixture (RM), wherein particular preference is given to ethylene glycol, 1,2-propanediol, 1,3-propanediol, 1,4-butanediol, diethylene glycol, trimethylolpropane and glycerol.

Component (b) more preferably consists of at least one alcohol selected from the group consisting of ethylene glycol, 1,2-propanediol, 1,3-propanediol, 1,4-butanediol, diethylene glycol, trimethylolethane, trimethylolpropane, trimethylolbutane and glycerol, wherein particular preference is given to ethylene glycol, 1,2-propanediol, 1,3-propanediol, 1,4-butanediol, diethylene glycol, trimethylolpropane and glycerol.

In a preferred embodiment, component (b) comprises at least two alcohols, wherein at least one alcohol comprises two hydroxyl groups and at least one alcohol comprises at least three hydroxyl groups. The alcohol comprising at least three hydroxyl groups preferably comprises at most six hydroxyl groups, particularly preferably at most four hydroxyl groups and especially preferably exactly three hydroxyl groups.

In this embodiment, the alcohol comprising two hydroxyl groups is preferably selected from ethylene glycol, 1,2-propanediol, 1,3-propanediol, 1,4-butanediol and diethylene glycol, and the alcohol comprising at least three hydroxyl groups is preferably selected from trimethylolethane, trimethylolpropane, trimethylolbutane and glycerol.

In this embodiment, component (b) preferably comprises at least 25% by weight, more preferably at least 50% by weight and particularly preferably at least 60% by weight and especially preferably at least 75% by weight of at least one alcohol comprising at least three hydroxyl groups, based on the total weight of component (b) in the reaction mixture (RM).

The at least one alcohol comprising at least two hydroxyl groups is especially preferably ethylene glycol, and the alcohol comprising at least three hydroxyl groups is especially preferably trimethylolpropane.

The molar ratio of component (a) to component (b) is preferably from 20:1 to 5:1, preferably from 15:1 to 7:1 and especially preferably from 12:1 to 9:1, based on the total amount of components (a) and (b) in the reaction mixture (RM).

Component (b) is preferably at least partially dissolved in component (a). The designation “at least partially dissolved” signifies here that preferably at least 5% by weight, more preferably at least 20% by weight and particularly preferably at least 50% by weight of component (b) is dissolved in component (a), based on the total weight of component (b).

Preferably at least 80% by weight, particularly preferably at least 90% by weight of component (b) is dissolved in component (a), based on the total weight of component (b) in the reaction mixture (RM). Component (b) is especially preferably completely dissolved in component (a) in the reaction mixture (RM). This means that the reaction mixture (RM) preferably does not comprise separate phases of component (a) and component (b).

Components (a) and (b) can be dissolved by means of all methods known to those skilled in the art. Components (a) and (b) are preferably dissolved while stirring.

Components (a) and (b) can be dissolved in principle at any desired temperature. Components (a) and (b) are preferably dissolved at a temperature in the range of 0 to 30° C.

Components (a) and (b) react with each other in the method according to the invention preferably by an addition reaction.

The reaction of the reaction mixture (RM) may in principle be effected at any desired temperature. The reaction mixture (RM) is preferably reacted at a temperature in the range of 20 to 90° C., more preferably in the range of 40 to 85° C., particularly preferably in the range of 50 to 80° C. and especially preferably in the range of 60 to 75° C. At a reaction temperature below 90° C., the formation of undesirable by-products in addition to the polyisocyanate (P) can be reduced or very largely avoided.

All figures below relating to the reaction mixture (RM) refer to the mixture prior to the reaction.

The reaction mixture (RM) preferably comprises 70 to 99% by weight component (a) and 1 to 30% by weight component (b), based on the total weight of the reaction mixture (RG).

The reaction mixture (RM) particularly preferably comprises 80 to 95% by weight component (a) and 5 to 20% by weight component (b) and especially preferably 85 to 92% by weight component (a) and 8 to 15% by weight component (b), based on the total weight of components (a) and (b) in the reaction mixture (RM).

The reaction mixture (RM) is preferably reacted in an inert gas atmosphere, particularly preferably in a nitrogen atmosphere.

The reaction of the reaction mixture (RM) can be carried out in the presence of at least one catalyst. However, the reaction of the reaction mixture (RM) is preferably carried out in the absence of a catalyst.

In the case that the reaction of the reaction mixture (RM) is carried out in the presence of at least one catalyst, the reaction conditions for the reaction are preferably selected such that the formation of reaction products having further functional groups such as allophanate, biuret, uretdione or isocyanurate groups, especially allophanate groups, are very largely avoided.

The reaction mixture (RM) is reacted therefore in the presence of a catalyst preferably at a temperature not exceeding 90° C., more preferably 85° C. and particularly preferably 80° C. and especially preferably 75° C.

In addition, the reaction of the reaction mixture (RM) is preferably terminated, preferably by cooling the reaction mixture (RM) to a temperature below 60° C., more preferably below 50° C. and particularly preferably below 40° C., as soon as at least one of components (a) or (b), preferably component (b), has fully reacted such that conversion products, which react with urethane groups, such as in particular allophanate groups, are not formed.

In the context of the present invention, catalysts are understood to be those compounds which induce or influence a chemical reaction but which are not themselves consumed. Suitable catalysts are known in principle to those skilled in the art.

Suitable catalysts include, for example, organic amines, especially tertiary aliphatic, cycloaliphatic or aromatic amines, Brrnsted acids and/or Lewis-acidic metallic compounds; particularly preferred are Lewis-acidic organometallic compounds.

Suitable tertiary aliphatic amines are, for example, triethylamine, N,N,N′,N′-tetramethylethylenediamine, N,N,N′,N′-tetramethylpropylenediamine, N,N,N′,N″,N″-pentamethyldiethylenetriamine, N,N,N′,N″,N″-pentamethyl-(3-aminopropyl)ethylenediamine, N,N,N′,N′,N″-pentamethyldipropylenetriamine, N,N,N′,N′-tetramethylguanidine, N, N, N′,N′-tetramethylhexamethylenediam ine, N, N-dimethylethanolamine, bis(2-dimethylaminoethyl)ether or mixtures thereof.

Suitable cycloaliphatic amines include, for example, triethylenediamine (1,4-diazabicyclo[2.2.2]octane, DABCO), 1,8-diazabicyclo[5.4.0]undec-7-ene (DBU), 1,5-diazabicyclo-[4.3.0]-non-5-ene (DBN), N-methyl-N′-(2-dimethylaminoethyl)piperazine, N,N′-dimethylpiperazine, N,N-dimethylcyclohexylamine, N-methylmorpholine, N-ethylmorpholine or mixtures thereof.

Aromatic amines suitable as catalysts are, for example, 1-methylimidazole, 1,2-dimethylimidazole, 1-isobutyl-2-methylimidazole, 1-(N, N-dimethylaminopropyl)imidazole or mixtures thereof.

Preferred organic amines are N,N,N′,N′-tetramethylethylenediamine, N,N,N′,N′-tetramethylpropylenediamine, N,N,N′,N′-tetramethylguanidine, triethylenediamine (1,4-diazabicyclo[2.2.2]octane, DABCO), 1,8-diazabicyclo[5.4.0]undec-7-ene (DBU), 1,5-diazabicyclo[4.3.0]non-5-ene (DBN), N,N′-dimethylpiperazine or mixtures thereof.

Suitable Brønsted acids include, for example, trifluoroacetic acid, sulfuric acid, hydrogen chloride, hydrogen bromide, phosphoric acid, perchloric acid or mixtures thereof.

Suitable Lewis-acidic organometallic compounds are particularly zinc compounds and tin compounds, particularly preferably those of carboxylic acids having at least two and up to twelve carbon atoms. Corresponding zinc compounds include, for example, zinc(II) stearate, zinc(II) n-octanoate, zinc(II) 2-ethylhexanoate, zinc(II) naphthenate, zinc(II) acetylacetonate or mixtures thereof. A commercially available zinc-containing catalyst is, for example, Borchi® Kat 22 from OMG Borchers GmbH, Langenfeld, Germany.

Tin compounds include, for example, tin(II) acetate, tin(II) n-octanoate, tin(II) 2-ethylhexanoate, tin(II) laurate, dibutyltin(IV) oxide, dibutyltin(IV) chloride, dibutyltin(IV) acetate, dibutyltin(IV) butyrate, dibutyltin(IV) 2-ethylhexanoate, dibutyltin(IV) laurate, dibutyltin(IV) maleate, dioctyltin(IV) acetate, dioctyltin(IV) laurate or mixtures thereof.

Further Lewis-acidic compounds include metal halides and metal complexes, preferably acetylacetonato complexes and other dionato complexes of iron, aluminum, zirconium, manganese, nickel and cobalt or mixtures thereof. Particularly preferred metal complexes are zirconium(IV) acetylacetonate and other zirconium(IV) dionates, and aluminum(III) dionates, which are obtainable under the names K-KAT® 4205, K-KAT® XC-9213; K-KAT@ XC-A 209, K-KAT® XC-6212 and K-KAT® 5218 from King Industries. Further metal catalysts are described by Blank et al. in Progress in Organic Coatings, 1999, vol. 35, pages 19 to 29.

Suitable tin-free and zinc-free alternatives are also cesium, bismuth and titanium compounds.

Useful cesium and bismuth compounds include those in which the following anions are used: F⁻, Cl⁻, ClO⁻, ClO₃⁻, ClO₄⁻, Br⁻, I⁻, IO₃⁻, CN⁻, OCN⁻, NO₂⁻, NO₃⁻, HCO₃⁻, CO₃²⁻, S₂⁻, SH⁻, HSO₃⁻, SO₃²⁻, HSO₄⁻, SO₄²⁻, S₂O₃²⁻, S₂O₄²⁻, S₂O₅²⁻, S₂O₆²⁻, S₂O₇²⁻, S₂O₈²⁻, H₂PO₂⁻, H₂PO₄⁻, HPO₄²⁻, PO₄³⁻, P₂O₇⁴⁻, (OCₙH₂ₙ₊₁), (CₙH₂ₙ₋₁O₂)⁻, (CₙH₂ₙ₋₃O₂) or (Cₙ₊₁H₂ₙ₋₂O₄)²⁻, where n represents the numbers 1 to 20. Preferred anions are anions of the formulae (CₙH₂ₙ₋₁O₂)⁻ or (Cₙ₊₁H₂ₙ₋₂O₄)₂⁻, where n represents the numbers 1 to 20, particular preference being given to anions of the formula (CₙH₂ₙ₋₁O₂)⁻, where n represents the numbers 1 to 20.

Preferred cesium and bismuth compounds are in particular cesium(I) formate, cesium(I) acetate, cesium(I) n-propionate, cesium(I) n-hexanoate, cesium(I) neodecanoate, cesium(I) 2-ethylhexanoate, bismuth(III) octanoate, bismuth(III) 2-ethylhexanoate, bismuth(III) neodecanoate or bismuth(III) pivalate or mixtures thereof.

Corresponding commercially available cesium- and bismuth-containing catalysts are, for example, K-KAT 348, XC-B221; XC-C227, XC 8203 and XK-601 from King Industries, TIB KAT 716, 716LA, 716XLA, 718, 720, 789 from TIB Chemicals and also, for example Borchi® Kat 24, Borchi® Kat 315 or Borchi® Kat 320 from OMG Borchers GmbH, Langenfeld, Germany.

Among the titanium compounds, preference is given to titanium(IV) alkoxides Ti(OR)₄, particular preference given to those of alcohols ROH having 1 to 8 carbon atoms, for example methanol, ethanol, isopropanol, n-propanol, n-butanol, isobutanol, sec-butanol, tert-butanol, n-hexanol, n-heptanol, n-octanol, preferably methanol, ethanol, isopropanol, n-propanol, n-butanol or tert-butanol, particularly preferably isopropanol and n-butanol.

The at least one catalyst is normally used, depending on activity, in amounts of 0.001 to 10 mol %, based on the total amount of isocyanate groups of component (a).

The reaction of the reaction mixture (RM) is preferably carried out without solvent but can also be carried out in the presence of at least one solvent. Suitable solvents are generally known to those skilled in the art.

Solvents used can in general be all solvents which do not comprise any groups that are reactive to isocyanate groups. Examples of such solvents are aromatic, aliphatic and/or cycloaliphatic hydrocarbons and mixtures thereof, chlorinated hydrocarbons, ketones, esters, alkoxylated alkyl alkanoates, ethers and mixtures of the solvents specified above.

By means of reaction of the reaction mixture (RM), the polyisocyanate (P) according to the aforementioned definitions is obtained.

In a preferred embodiment, the reaction of the reaction mixture (RM) is terminated after at least a portion of components (a) and (b) has reacted. The reaction of the reaction mixture (RM) is preferably only terminated after at least one of components (a) or (b), preferably component (b), has completely reacted. The reaction of the reaction mixture (RM) can be terminated by any methods known to those skilled in the art.

The reaction of the reaction mixture (RM) is preferably terminated by the addition of at least one component (c), after at least a portion of components (a) and (b) has reacted.

The at least one component (c) prevents a further reaction of polyisocyanate (P) with further molecules of polyisocyanate (P) or with other compounds present in the reaction mixture (RM) and thus ensures higher product purity. In particular, the use of the at least one component (c) means that the formation of compounds having allophanate groups or isocyanurate groups can be avoided as far as possible.

Suitable components (c) include, for example, organic acids and acid chlorides such as benzenesulfonic acid, benzenesulfonyl chloride, toluenesulfonic acid, toluenesulfonyl chloride, benzoic acid, benzoyl chloride, benzyl chloride, phosphorous acid, phosphoric acid or acidic esters of phosphorous acid or phosphoric acid such as dibutyl phosphite, dibutyl phosphate or di(2-ethylhexyl) phosphate for example.

The at least one component (c) is preferably selected from toluenesulfonic acid, toluenesulfonyl chloride, benzoyl chloride, benzyl chloride, dibutyl phosphite, dibutyl phosphate or di-(2-ethylhexyl) phosphate.

Still unreacted amounts of component (a) and component (b) are preferably removed from the polyisocyanate (P). The removal can be effected here by all methods known to those skilled in the art, for example by thin-film distillation, extraction, crystallization or molecular distillation. The removal is particularly preferably effected by thin-film distillation.

Components (a) and (b) are removed from the polyisocyanate (P) preferably using inert protic or aprotic solvents. Suitable solvents have already been described above, inter alia, and are those which do not comprise any groups that are reactive to isocyanate groups.

The polyisocyanate (P) produced by the method according to the invention is suitable in many technical sectors, for example as crosslinking reagent in clearcoats, adhesives, coating compositions and automobile paints, preferably as crosslinking reagent in clearcoats.

The present invention thus further provides the use of polyisocyanate (P) as crosslinking reagent in clearcoats.

The following examples are intended to more particularly elucidate the present invention but without limiting the present invention thereto.

### EXAMPLES

The at least one cyclic isocyanate (a) (component (a)) used in the following working examples is MCDI (a mixture of 1,3-diisocyanato-4-methylcyclohexane and 1,3-diisocyanato-2-methylcyclohexane). The alcohol comprising two hydroxyl groups used in the following examples is diethylene glycol. The alcohol comprising at least three hydroxyl groups used in the following examples is trimethylolpropane.

The content of NCO groups in polyisocyanates is determined by the methods described hereinafter:

0.5 g of a polyisocyanate-containing mixture is precisely weighed and dissolved in 100 ml of N-methylpyrrolidone. To this solution are added 10 ml of a 1N solution of n-dibutylamine in xylene. The mixture thus obtained is left to stand at room temperature for 15 minutes, whereupon the polyisocyanate and n-dibutylamine react with each other. After reaction is complete, the mixture formed is back-titrated with 1N hydrochloric acid in order to determine the total volume of hydrochloric acid that is necessary to neutralize unreacted n-dibutylamine in the mixture.

The polyisocyanates obtained by the method according to the invention are characterized by means of gel permeation chromatography (GPC).

Instrument description of the GPC system:
Injector: Autosampler WATERS 717 Plus
Eluent: Tetrahydrofuran (flow rate: 0.5 ml/min)
Pump: WATERS Model 515 (double piston pump)
Detector 1: UV detector WATERS 2489 (wavelength: 254 nm)
Detector 2: Differential refractometer WATERS 2414 (measurement temperature: 35° C.)
Column attachment: PL gel columns (600×7.5 mm), 4 columns connected in series
Column packing: crosslinked polystyrene-divinylbenzene matrix, particle size 5 μm
Pore width: 1×50 Å
   3×100 Å
Calibration: Basonat HI 100, molar mass range 2200-168 g/mol
Software: PSS WinGPC Unity NT

### Comparative Example 1

500 g of isophorone diisocyanate (IPDI), 44 g of trimethylolpropane and 14.16 g of diethylene glycol are initially charged in a 1 l three-necked flask with thermometer (linked to an oil bath with adjustable temperature), stirrer, reflux condenser and nitrogen inlet and heated to 80° C. while stirring. The alteration of the NCO content during the reaction of the starting materials is determined by titration as detailed above. The reaction is terminated by adding 300 ppm of a mixture of benzyl chloride and bis(2-ethylhexyl) phosphate (50/50% by weight), after the NCO content has reached the theoretical value for the complete reaction of the isophorone diisocyanate with trimethylolpropane and diethylene glycol. The colorless composition thus obtained is purified by thin-film distillation at 3 mbar and 175° C. in order to remove unreacted isophorone diisocyanate.

240.1 g of this composition are dissolved in 102.9 g of butyl acetate. The resulting yellowish solution (70% by weight in butyl acetate) has an NCO content of 8.6% and a viscosity of 1810 mPa-s.

### Working Example 1

500 g of MCDI, 44 g of trimethylolpropane and 14.16 g of diethylene glycol are initially charged in a 1 l three-necked flask with thermometer (linked to an oil bath with adjustable temperature), stirrer, reflux condenser and nitrogen inlet and heated to 80° C. while stirring. The alteration of the NCO content during the reaction of the starting materials is determined by titration as detailed above. The reaction is terminated by adding 300 ppm of a mixture of benzyl chloride and bis(2-ethylhexyl) phosphate (50/50% by weight), after the NCO content has reached the theoretical value for the complete reaction of the MCDI with trimethylolpropane and diethylene glycol. The colorless composition thus obtained is purified by thin-film distillation at 3 mbar and 175° C. in order to remove unreacted isophorone diisocyanate.

251.1 g of this composition are dissolved in 107.6 g of butyl acetate. The resulting yellowish solution (70% by weight in butyl acetate) has an NCO content of 10.6% and a viscosity of 2000 mPa·s.

1: A polyisocyanate of formula (I): 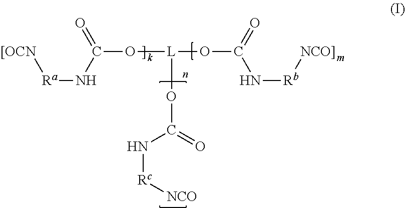
where
k, m, n are each independently 0, 1, 2 or 3, wherein a sum total of k, m and n is at least 2 and at most 6; and
L is a linear or branched organic radical having at most 14 carbon atoms, which optionally comprises at least one nitrogen atom and/or at least one oxygen atom,
R^{a}, R^{b}, R^{c} are each independently selected from the group consisting of radicals of formulae (IIa), (IIb), (IIc), (IId), (IIe) and/or (IIf): 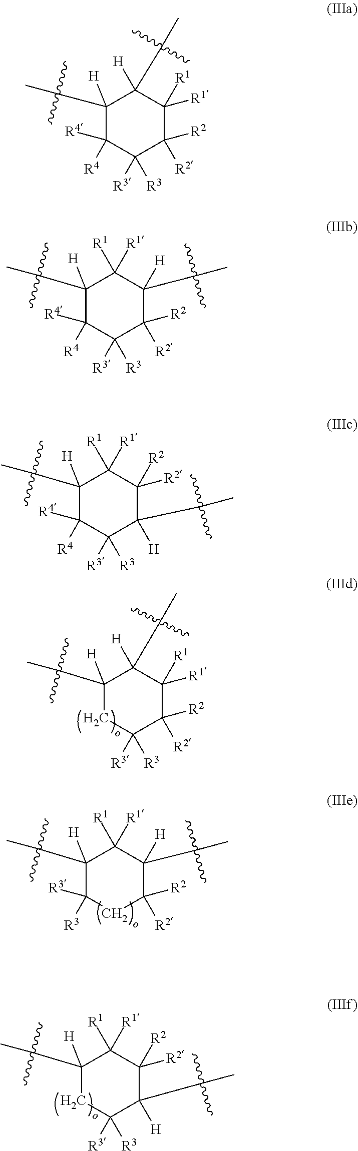
where
o is 0 to 10, and
R¹, R^{1′}, R², R^{2′}, R³, R^{3′}, R⁴, R^{4′} are each independently selected from the group consisting of H, OR⁵ and unsubstituted or at least monosubstituted C₁-C₁₀-alkyl, C₅-C₁₂-cycloalkyl, C₂-C₁₀-alkenyl and C₆-C₁₄-aryl, where R⁵ is C₁-C₁₀-alkyl.

2: The polyisocyanate according to claim 1, wherein
L is a linear or branched aliphatic, cycloaliphatic or aromatic radical having at most 14 carbon atoms, which optionally comprises at least one nitrogen atom and/or at least one oxygen atom, and
R^{a}, R^{b}, R^{c} are each independently selected from the group consisting of the radicals of formulae (IIa), (IIb), (IIc), (IId), (IIe) and/or (IIf),
where
o is 0, 2 or 3, and
R¹, R^{1′}, R², R^{2′}, R³, R^{3′}, R⁴, R^{4′} are each independently selected from the group consisting of H and C₁-C₁₀-alkyl.

3: The polyisocyanate according to claim 1, wherein
L is a linear or branched aliphatic or cycloaliphatic radical having at most 14 carbon atoms, which optionally comprises at least one nitrogen atom and/or at least one oxygen atom,
R^{a}, R^{b}, R^{c} are each independently selected from the group consisting of the radicals of formulae (IIa), (IIb) and/or (IIc),
where
R¹, R^{1′}, R², R^{2′}, R³, R^{3′}, R⁴, R^{4′} are each independently selected from the group consisting of H, methyl, ethyl and propyl.

4: The polyisocyanate according to claim 1, wherein
k is 2 or 3, and
m, n are 0, and
L is a linear or branched aliphatic radical having at most 10 carbon atoms, which optionally comprises at least one nitrogen atom and/or at least one oxygen atom,
R^{a} is selected from the group consisting of the radicals of formulae (IIa), (IIb) and/or (IIc): 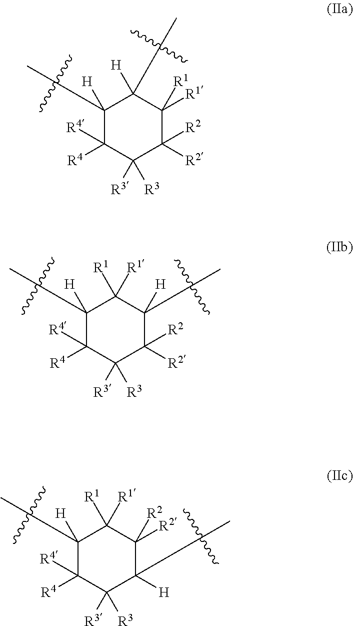
where
R¹, R^{1′}, R², R^{2′}, R³, R^{3′}, R⁴, R^{4′} are each independently selected from the group consisting of H, methyl and ethyl,
wherein at least one radical of R¹, R^{1′}, R², R^{2′}, R³, R^{3′}, R⁴ or R^{4′} is methyl or ethyl.

5: The polyisocyanate according to claim 1, wherein
k is 3, and
m, n are 0, and
L is a linear or branched aliphatic radical having at most 6 carbon atoms, which optionally comprises at least one oxygen atom,
R^{a} is a radical of the formula (IIb): 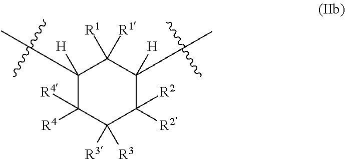
where
R¹, R^{1′}, R², R^{2′}, R³, R^{3′}, R⁴, R^{4′} are each independently selected from the group consisting of H, methyl and ethyl,
wherein at least one radical and at most 3 radicals of R¹, R^{1′}, R², R^{2′}, R³, R^{3′}, R⁴ or R^{4′} are methyl or ethyl.

6: A polyisocyanate of formula (IV): 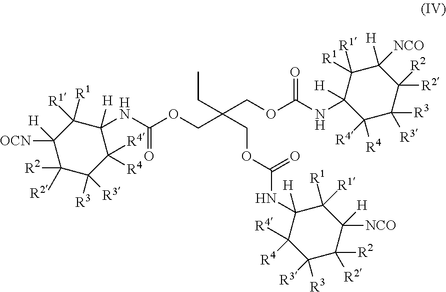
where
R¹, R^{1′}, R², R^{2′} are each independently selected from the group consisting of H and methyl, wherein at least one radical and at most two radicals of R¹, R^{1′}, R² or R^{2′} are methyl, and
R³, R^{3′}, R⁴ and R^{4′} are H.

7: A method for preparing the polyisocyanate according to claim 1, the method comprising reacting a reaction mixture comprising components (a) and (b):
(a) at least one cyclic isocyanate of formulae (IIIa), (IIIb), (IIIc), (IIId), (IIIe) and/or (IIIf): 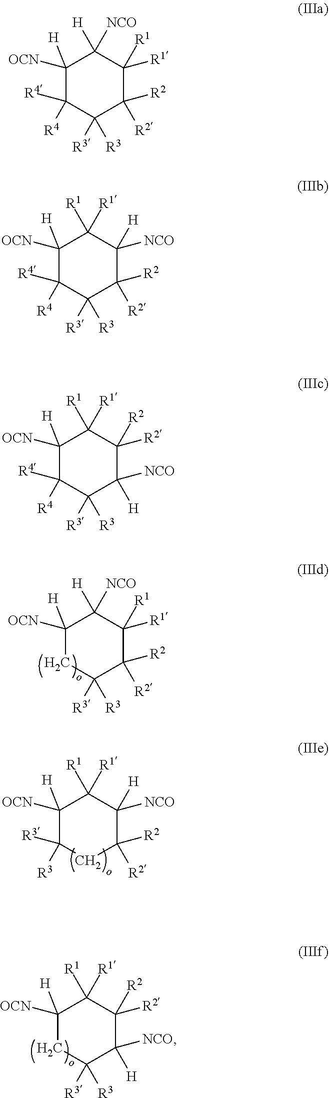
where
o is 0 to 10, and
R¹, R^{1′}, R², R^{2′}, R³, R^{3′}, R⁴, R^{4′} are each independently selected from the group consisting of H, OR⁵ and unsubstituted or at least monosubstituted C₁-C₁₀-alkyl, C₅-C₁₂-cycloalkyl, C₂-C₁₀-alkenyl and C₆-C₁₄-aryl,
where R⁵ is C₁-C₁₀-alkyl, and
(b) at least one alcohol having at least two hydroxyl groups, to obtain a composition (C) comprising the polyisocyanate.

8: The method according to claim 7, wherein the component (a) is selected from the group consisting of 1,3-diisocyanatocyclohexane, 1,3-diisocyanato-2-methylcyclohexane, 1,3-diisocyanato-4-methylcyclohexane, 1,3-diisocyanato-5-methylcyclohexane, 1,3-diisocyanato-2-isopropylcyclohexane, 1,3-diisocyanato-4-isopropylcylohexane, 3-diisocyanato-5-isopropylcyclohexane, 1,3-diisocyanato-2,4-dimethylcyclohexane, 1,3-diisocyanato-2,4-diethylcyclohexane, 1,3-diisocyanato-2,4-diethyl-6-methylcyclohexane, 1,3-diisocyanato-2-methyl-4,5-diethylcyclohexane, 1,3-diisocyanato-2,4,6-triisopropylcyclohexane, and 1,3-diisocyanato-2,4,6-tributylcyclohexane.

9: The method according to claim 7, wherein the component (b) is selected from the group consisting of ethylene glycol, 1,1-dimethylethylene glycol, 1,2-propanediol, 1,3-propanediol, 2-methyl-1,3-propanediol, 2-ethyl-1,3-propanediol, 2-butyl-2-ethyl-1,3-propanediol, 1,4-butanediol, 2-ethyl-1,4-butanediol, 1,5-pentanediol, 2-methyl-1,5-pentanediol, neopentyl glycol, 1,6-hexanediol, 2-ethyl-1,3-hexanediol, 2,4-diethyloctane-1,3-diol, diethylene glycol, triethylene glycol, tetraethylene glycol, pentaethylene glycol, dipropylene glycol, tripropylene glycol, trimethylolethane, trimethylolpropane, trimethylolbutane, ditrimethylolpropane, pentaerythritol, dipentaerythritol, glycerol, cyclohexane-1,2-diol, cyclohexane-1,3-diol, cyclohexane-1,4-diol, 1,1-bis(hydroxymethyl)cyclohexane, 1,2-bis(hydroxymethyl)cyclohexane, 1,3-bis(hydroxymethyl)cyclohexane, 1,4-bis(hydroxymethyl)cyclohexane, 2,2-bis(4-hydroxycyclohexyl)propane, erythritol, threitol, xylitol, adonitol (ribitol), arabitol (lyxitol), sorbitol, mannitol, dulcitol (galactitol), maltitol, isomalt, diglycerol, dimethylolpropane, dipentaerythritol, ribose, arabinose, glucose, mannose, galactose, fructose, pyrocatechol, catechol, hydroquinone, pyrogallol, hydroxyhydroquinone, phloroglucinol, neopentyl glycol hydroxypivalate, triethanolamine, tripropanolamine, 1,3,5-tris(2-hydroxyethyl)cyanuric acid, a polytetrahydrofuran having a molecular weight between 162 and 4500 g/mol, a poly-1,3-propanediol or a polypropylene glycol having a molecular weight between 134 and 2000 g/mol, and a polyethylene glycol having a molecular weight between 238 and 2000 g/mol.

10: The method according to claim 7, wherein the component (b) comprises at least two alcohols, at least one alcohol comprises two hydroxyl groups, and at least one alcohol comprises three hydroxyl groups.

11: The method according to claim 7, wherein the reaction mixture comprises 70 to 99% by weight of the component (a) and 1 to 30% by weight of the component (b), based on a total weight of components (a) and (b) in the reaction mixture.

12: The method according to claim 7, wherein
i) the reaction mixture is reacted at a temperature in the range from 20° C. to 90° C., and/or
ii) the reaction mixture is reacted in the absence of a catalyst.

13: The method according to claim 7, further comprising:
terminating the reaction of the reaction mixture by adding at least one component (c), after at least a portion of the components (a) and (b) has been reacted.

14: The method according to claim 7, further comprising
terminating the reaction after at least one of the components (a) or (b) has been fully reacted, and/or
separating unreacted amounts of the component (a) and/or (b) from the composition (C).

15: A method for crosslinking in a clearcoat, the method comprising:
Introducing the polyisocyanate according to claim 1 as a crosslinking reagent into the clearcoat.

16: The method according to claim 13, wherein the at least one component (c) is selected from the group consisting of toluenesulfonic acid, toluolsulfonyl chloride, benzoyl chloride, benzyl chloride, dibutyl prosphite, cibutyl phosphate, and di-12-ethylhexyl phosphate.
